(19) United States
(12) Patent Application Publication
(10) Pub. No.: US 2004/0110546 A1
(43) Pub. Date: Jun. 10, 2004

(54) Mobile communication terminal with hinge apparatus

(75) Inventor: Chang-Bai Won, Gyeonggi-Do (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/724,383

(22) Filed: Nov. 26, 2003

(30) Foreign Application Priority Data
Nov. 29, 2002 (KR) 10-2002-75485

(51) Int. Cl. H04M 1/00

(52) U.S. Cl. 455/575.1; 455/550.1

(57) ABSTRACT

A folding type mobile communication terminal, wherein a hinge apparatus rotatively couples an upper body to a lower body, is disclosed. The hinge apparatus includes first and second hinge housings, first and second hinge members, a coupling hinge member, a spring, and rotation control device. The first and second hinge members are inserted into the first and second hinge housings, respectively. The coupling hinge member is disposed between the first and second hinge members. Relationships between the first and second hinge members and the coupling hinge member include interlocking features assisted by the elastic force of the spring. A user manipulates the rotation control device to effect an opening angle of the folding type terminal.

### CROSS REFERENCE TO RELATED APPLICATIONS

Pursuant to 35 U.S.C. §119(a), this application claims the benefit of earlier filing date and right of priority to the Korean Patent Application No. 2002-75485, filed on Nov. 29, 2002, the content of which is hereby incorporated by reference in its entirety.

### BACKGROUND OF THE INVENTION

1. Field of the Invention

The present invention relates to a hinge apparatus for a mobile communication terminal, and more particularly, to a hinge apparatus for a folding type mobile communication terminal that facilitates user manipulation of the opening angle between the first and second bodies.

2. Description of Related Art

In general, mobile communication terminals include cellular phones or Personal Communication Systems (PCS) having wireless communication capabilities. As the need for smaller devices for communication grows, several folding type mobile communication terminals having clam-shell designs have been suggested to satisfy this demand.

Referring to FIG. 1, a folding type mobile terminal is shown. The folding type conventional mobile terminal comprises a lower body 1, on which one or more terminal manipulation devices 1a, for example buttons, are disposed on the upper surface of the lower body 1. A hinge H is installed on the top edge of the upper surface and rotatively couples the upper body 2 of the terminal. A display screen 2a is disposed on the lower surface of the upper body 2 to display message and terminal information. Benefits of the folding type construction of mobile communication terminal include additional protection of the display screen 2a and terminal manipulation devices la from physical damage and exposure to moisture. Also, the overall size of the terminal is reduced, thereby reducing the carrying burden on the user and facilitating transportation.

Several types of a hinge apparatus have also been suggested for folding type mobile communication terminals. In FIGS. 2-3B, a click hinge apparatus according to the related art is shown. A first hinge housing 1b is formed on opposing side edges of the lower body 1 of the terminal. A first hinge member 11 is inserted into the first hinge housing 1b. A second hinge housing 2b is formed on the lower side edge of the upper body 2 of the terminal. A second hinge member 12 is inserted into the second hinge housing 2b. Hinge contact surfaces 1c and 2c are formed on the inner surfaces of the first and second hinge housings 1b and 2b, respectively. Rotation-preventing surfaces 11a and 12a, which are formed on the outer circumferential surfaces of the first and second hinge members 11 and 12, respectively, engage the hinge contact surfaces 1c and 2c, respectively, to prevent axial rotation of the hinge members 11 and 12. A shaft 14 supports a spring 13 and the first and second hinge members 11 and 12.

Opposing surfaces of the first and second hinge members 11 and 12 each contain corresponding concave ( 11c, 12b) and convex (11b, 12c) portions. The elastic force of the spring 13 ensures contact between the concave portion 11c and convex portion 12b and between the concave portion 12c and the convex portion 1b, thereby “locking” the terminal in a folded or unfolded state. Consequently, when a user folds or unfolds the terminal, the second hinge member 12 rotates with the upper body 2 of the terminal (as indicated by the rotational arrow in FIG. 3A). Accordingly, the convex portion of the second hinge member 12b pushes against the convex portion 11b of the first hinge member 11 during rotation, thereby compressing the spring 13 (as indicated by the direction arrow in FIG. 3A). As the convex portion 12b passes over the convex portion 11b, the elastic force of the spring 13 restitutes the first and second hinge members so that the convex portions 11c and 12b engage the concave portions 11b and 12c.

In FIGS. 4-5B, a free stop hinge apparatus according to related art is shown. Similar to the click hinge apparatus described above, the free stop hinge apparatus for a folding type mobile communication terminal includes: first and second hinge housings 1b, 2b; first and second hinge members 15, 16; first and second hinge contact surfaces 1c, 2c; and first and second rotation-preventing surfaces 15a, 16a. A shaft 18 supports a spring 17, and first and second hinge member 15 and 16. When the hinge contact surfaces 1c and 2c engage the rotation-preventing surfaces 15a and 16a, respectively, axial rotation of the first and second hinge members 15 and 16 is prevented within the first and second hinge housings 1b and 2b, respectively.

Opposing surfaces of the first and second hinge members 15 and 16 contain guiding surfaces 15b and 16b, respectively. The guiding surface 15b includes a groove 15c, which corresponds to and engages with a protrusion 16c on the guiding surface 16b. The elastic force of the spring 17 ensures contact between the guiding surfaces 15b and 16b so that when the protrusion 16c is operationally engaged with the groove 15c, the terminal is “locked” in a folded or unfolded state. Consequently, when a user folds or unfolds the terminal, the second hinge member 16 rotates with the upper body 2 of the terminal (as indicated by the rotational arrow in FIG. 5A). Accordingly, the protrusion 16c disengages the groove 15c, thereby compressing the spring 17 (as indicated by the direction arrow in FIG. 5A). The elastic force of the spring 17 creates friction between the protrusion 16c and the guiding surface 15b during rotation. This frictional force allows a user to maintain a desired opening angle when unfolding or folding a terminal.

As shown by the click hinge apparatus, when the user unfolds the terminal, the opening angle created by the upper and lower bodies of the terminal is maximized. Although this type of hinge apparatus may prevent unintentional folding and unfolding of the terminal, a user cannot maintain privacy when utilizing the terminal for non-voice communications, such as text messaging.

With respect to a free stop hinge apparatus, friction between moving parts within the hinge is utilized to allow the user to maintain an opening angle that is neither the maximum (i.e., fully open) or the minimum (i.e., fully closed). Unfortunately, general erosion by friction of such moving parts after repetitive movement occurs, thereby decreasing the effectiveness of friction as a single and only means for angle control and locking.

Therefore, an improved solution is required to effectively allow a user to manipulate the opening angle of a folding type mobile communication terminal.

### SUMMARY OF THE INVENTION

Accordingly, the present invention is directed to a hinge apparatus for a folding type mobile communication terminal that substantially obviates one or more problems due to limitations and disadvantages of the related art above.

An object of the present invention is to provide a hinge apparatus of a folding type mobile communication terminal, wherein the opening angle can be controlled by the user.

Another object of the present invention is to provide a hinge apparatus of a folding type mobile communication terminal, wherein convenience in folding and unfolding the terminal is improved.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a mobile communication terminal comprising a first body, a second body and a hinge apparatus, which rotatively couples the first body to the second body. The hinge apparatus comprises a first hinge unit; a second hinge unit; a coupling hinge member disposed between the first and second hinge units; and a rotation control device.

According to one aspect of the present invention, the first hinge unit comprises a first hinge housing formed approximate to a side edge of the first body, and a first hinge member inserted into the first hinge housing. Also, the second hinge unit comprises a second hinge housing formed approximate to a bottom edge of the second body, a second hinge member inserted into the second hinge housing, and a spring disposed adjacent to the second hinge member in the second hinge housing.

According to another aspect of the present invention, guiding surfaces are formed on opposing surfaces of the first hinge member and coupling hinge member. Furthermore, a groove is formed on the guiding surface of the first hinge member and engages a corresponding protrusion formed on the guiding surface of the coupling hinge member.

According to another aspect of the present invention, a convex portion and a concave portion are each formed on opposing surfaces of the coupling hinge member and the second hinge member such that the convex and concave portions of the coupling hinge member correspond to the concave and convex portions, respectively, of the second hinge member.

According to another aspect of the present invention, the terminal may further comprise rotation-preventing surfaces formed on a circumferential surface of each of the first, second and coupling hinge members. Furthermore, first and second hinge contact surfaces are formed on an inner surface of each of the first and second hinge housing members, respectively. The first and second hinge contact surfaces engage the rotation-preventing surfaces of the first and second hinge members, respectively, to prevent rotation of the first and second hinge members, respectively.

According to another aspect of the present invention, the rotation control device may comprises a cap receiving portion formed on an inner surface of the first hinge housing; a rotation control cap; a cap receiving groove formed on the cap receiving portion; a cap protrusion formed on a outer circumferential surface of the rotation control cap; a female screw thread formed on an inner circumferential surface of the rotation control cap; and a male screw thread formed on a circumferential surface of the first hinge member. The rotation control cap has an exposed portion to serve as a receiving point for torque applied by a user. Also, the cap receiving groove receives the cap protrusion and the male screw thread engages the female screw thread of the rotation control cap.

According to one aspect of an alternative embodiment of the present invention, a protrusion is formed on each of the inner surfaces of the first hinge housing and rotation control caps such that the protrusion formed on the inner surface of the first hinge housing prevents lateral movement of the rotation control cap towards the second hinge housing.

It is to be understood that both the foregoing general description and the following detailed description are exemplary and explanatory and are intended to further describe the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a perspective view of a folding type mobile communication terminal according to the related art;

FIG. 2 illustrates a disassembled perspective view of a hinge apparatus according to the related art;

FIGS. 3A and 3B illustrate sectional views of the hinge apparatus of FIG. 2 during operation;

FIG. 4 illustrates a disassembled perspective view of a hinge apparatus according to the related art;

FIGS. 5A and 5B illustrate sectional views of the hinge apparatus of FIG. 4 during operation;

FIG. 6 illustrates a perspective view of a folding type mobile communication terminal with a hinge apparatus according to one embodiment of the present invention;

FIG. 7 illustrates a disassembled perspective view of a hinge apparatus according to one embodiment of the present invention;

FIG. 8 illustrates a sectional view of a hinge apparatus according to one embodiment of the present invention;

FIG. 9 illustrates a cross sectional view of the hinge apparatus along line I in FIG. 4;

FIG. 10 illustrates a cross sectional view of the hinge apparatus along line II in FIG. 4;

FIG. 11 illustrates a cross sectional view of the hinge apparatus along line III in FIG. 4;

FIGS. 12A and 12B illustrate sectional views of a hinge apparatus, according to one embodiment of the present invention, during operation;

FIGS. 13A and 13B illustrate sectional views of a hinge apparatus, according to one embodiment of the present invention, during operation; and

FIG. 14 illustrates a sectional view of a hinge apparatus, according to an alternative embodiment of the present invention, during operation.

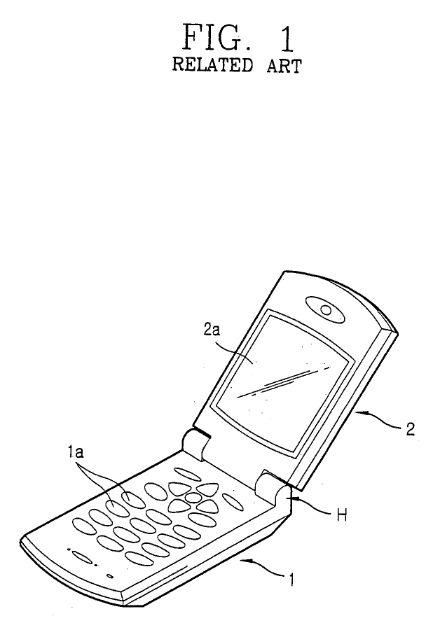

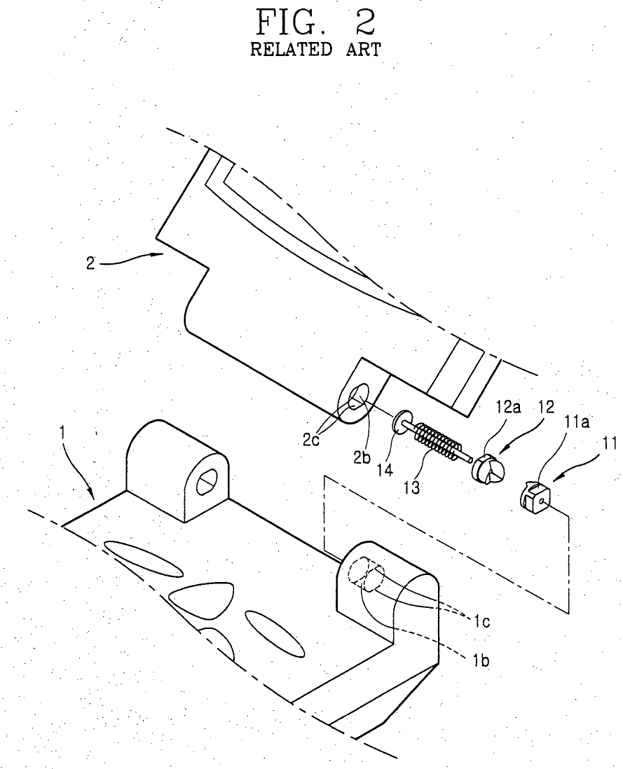

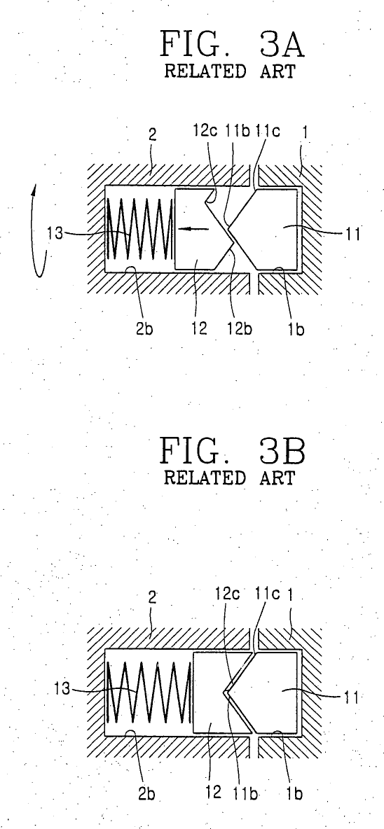

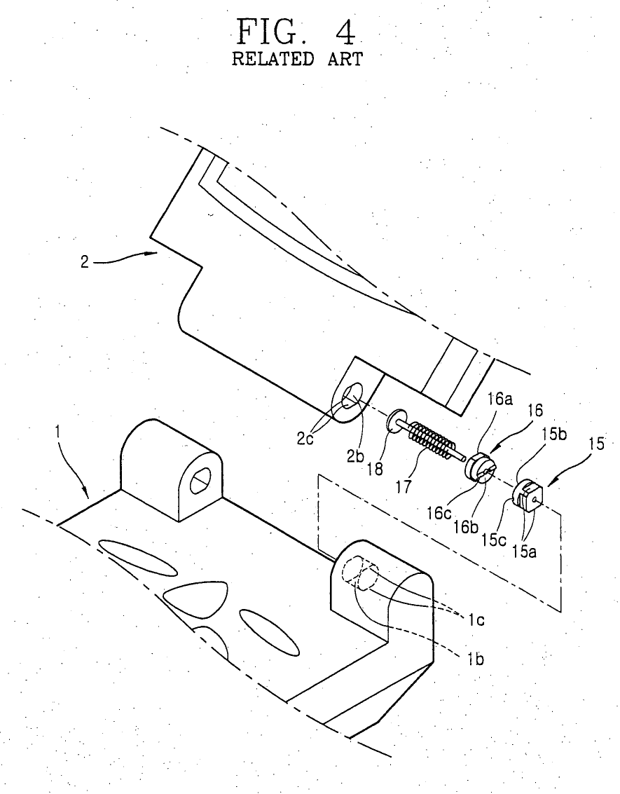

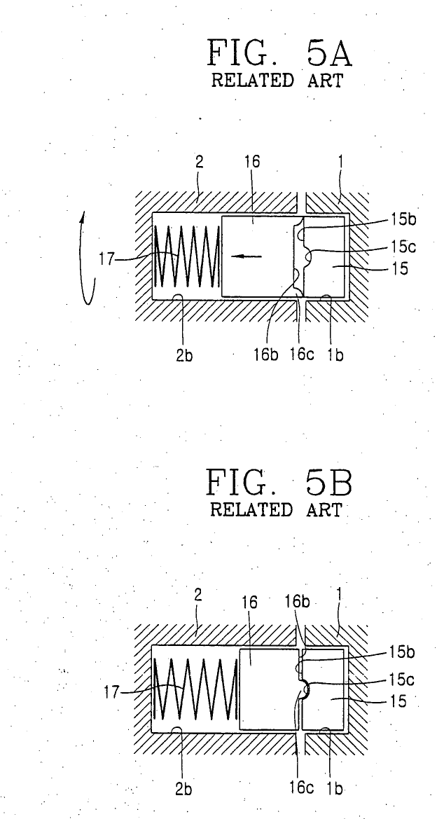

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

Reference will now be made in detail to one or more embodiments of the invention, examples of which are illustrated in the accompanying drawings.

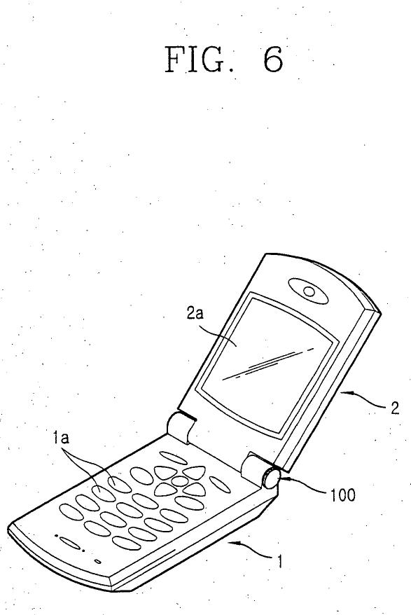

In FIG. 6, a folding type mobile communication terminal with a hinge apparatus 100, in accordance with one embodiment of the present invention, is illustrated. The terminal comprises a first body 1 on which one or more terminal manipulation devices 1a, for example buttons, are disposed on an inner surface of the first body 1. The hinge apparatus 100, which is situated on the top edge of the inner surface of the first body 1, rotatively couples the first body 1 to the second body 2. A screen display 2a, such as a liquid crystal display screen, for example, is disposed on the inner surface of the second body 2 to provide message and terminal information to the user.

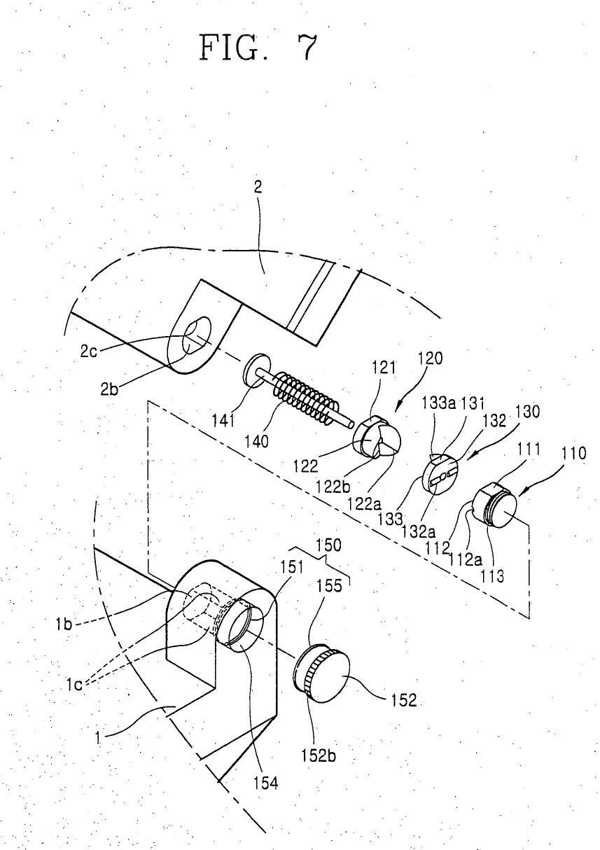

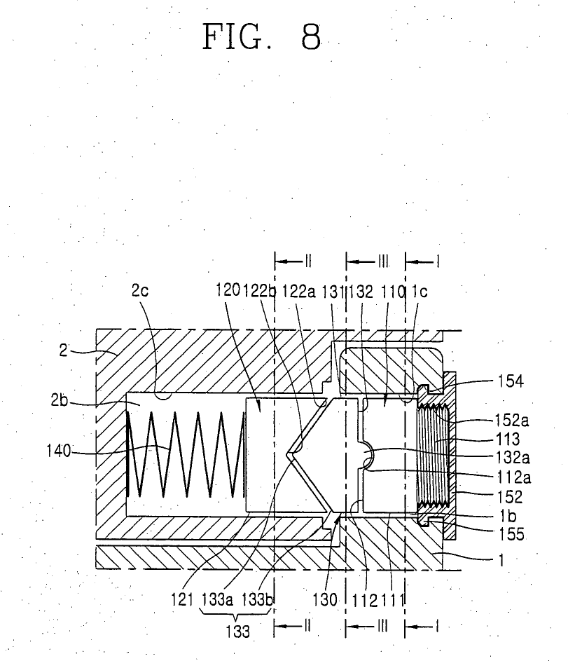

Referring to FIGS. 7 and 8, the hinge apparatus 100 comprises a first hinge housing 1b disposed on preferably both opposing side edges of the first body 1, on its inner surface and approximate to the top edge. A first hinge member 110 is inserted into the first hinge housing 1b. A second hinge housing 2b is formed approximate to the center of the bottom edge of the second body 2. A second hinge member 120 is inserted into the second hinge housing 2b. A coupling hinge member 130 is installed between the first hinge member 110 and the second hinge member 120. The coupling hinge member 130 is selectively engaged by the user to rotate with either the first hinge housing 1b or the second hinge housing 2b, as described in greater detail below.

A spring 140 is installed adjacent to the second hinge member 120 opposite the coupling hinge member 130. A shaft 141 is installed in the second hinge housing 2b and passes through the centers of the spring 140, the second hinge member 120, and the coupling hinge member 130. The second hinge member 120 and the coupling hinge member 130 to slidingly move along the shaft 141.

A rotation control device 150 is installed on the outer edge of the first hinge housing 1b. Manipulation of the rotation control device 150 engages the device 150 with the first hinge member 110 so as to operationally engage and rotate the coupling hinge member 130.

The rotation control device 150 comprises a cap receiving portion 151 formed on the inner surface of the first hinge housing 1a, which receives the rotation control cap 152. A cap receiving groove 154 is formed on the cap receiving portion 151 and engages with a protruding cap thread 155, which is formed on the circumferential surface of a rotation control cap 152. The operational relationship of the receiving groove 154 and the protruding cap thread 155 prevents the rotation control cap from disengaging with the terminal as well as preventing the first hinge member 110 from falling out of the first hinge housing 1b. Female screw threads 152a are formed on the inner circumferential surface of the rotation control cap 152 and engage male screw threads 113 formed on the circumferential surface of the first hinge member 110. The exposed portion 152b of the rotation control cap 152 is preferably fitted with gripping means, such as knurls for example, to prevent slippage when rotating the cap 152.

Guiding surfaces 112 and 132 are formed on opposing surfaces of the first hinge member 110 and the coupling hinge member 130, respectively. A groove 112a is formed, preferably diametrically, on the guiding surface 112. Correspondingly, a protrusion 132a, which engages the groove 112a, is formed, preferably diametrically, on the guiding surface 132. Furthermore, a convex portion 122a and a concave portion 122b are formed on a guiding surface 122 of the second hinge member 120. The guiding surface 122 is opposite a guiding surface 133 of the coupling hinge member 130. A concave portion 133a and convex portion 133b are formed on the guiding surface 130 to correspond and operationally engage with the convex portion 122a and concave portion 122b, respectively.

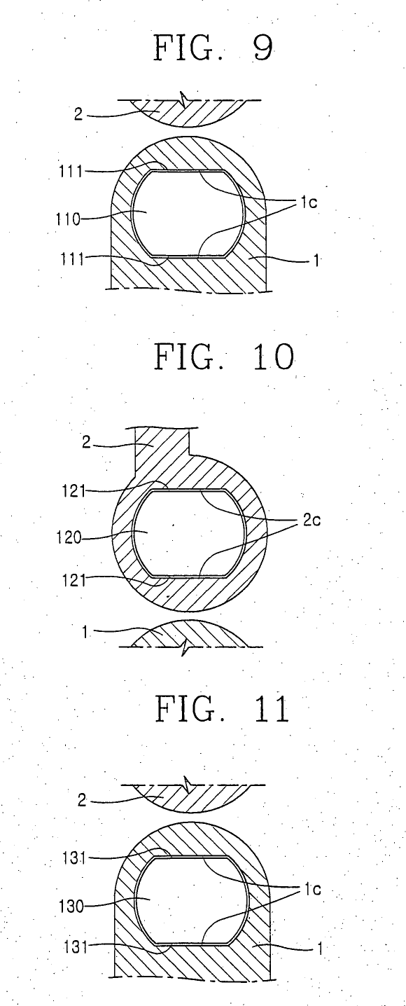

Referring to FIGS. 9-11, a first hinge member contact surface 1c is formed on the inner surface of the first hinge housing 1b. Similarly, a second hinge member contact surface 2c is formed on the inner surface of the second hinge housing 2b. Rotation-preventing surfaces 111 and 121, are formed on the circumferential surfaces of the first and second hinge members 110, 120, respectively. Preferably, the rotation-preventing surface 111 is formed on the circumferential surface of the first hinge member 110 adjacent to the male screw threads 113 away from the outer edge of the terminal's first body 1. The rotation-preventing surfaces 111 and 121 correspond to and operationally engage with the first and second member contact surfaces 1c, 2c, respectively. The coupling hinge member 130 also comprises a rotation-preventing surface 131 on its circumferential surface. The rotation-preventing surface 131 is selectively engaged by the user to operationally engage with either of the first or second hinge member contact surfaces 1c, 2c, as discussed in greater detail below.

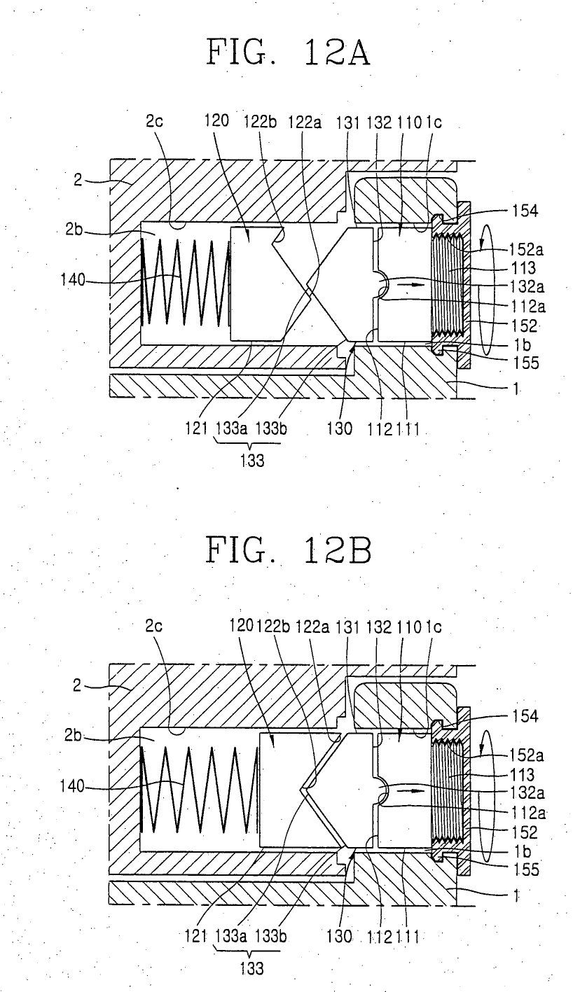

FIGS. 12A and 12b illustrate the operation of a hinge apparatus according to one embodiment of the present invention. In FIG. 12A, a user rotates the rotation control cap 152 in a clockwise direction (as indicated by the circular arrow). Consequently, the female screw threads 152a operationally engage the male screw threads 113 of the first hinge member 110, resulting in lateral movement of the first hinge member 110 towards the outer edge of the terminal's first body 1 (as indicated by the directional arrow). In other words, the first hinge member 110 is pulled outwards. Also, the first hinge member is pushed outwards from the elastic force released by the compressed spring 140. Furthermore, expansion of the spring 140 results in the coupling hinge member 130 being slidingly moved so that the rotation-preventing surface 131 is now in contact with the first hinge member contact surface 1c.

At this stage, when a user unfolds the terminal, the second hinge member 120 rotates with the second body 2. Consequently, the convex portion 133b of the coupling hinge member 130 pushes against the convex portion 122a of the second hinge member 120. Accordingly, the second hinge member 120 is pushed inwards (opposite the direction of the coupling hinge member 130), thereby compressing the spring 140.

Referring to FIG. 12B, continued unfolding of the terminal results in the convex portion 122a of the second hinge member 120 passing over the convex portion 133b of the coupling hinge member 130. At this moment, restitution force of the spring 140 results in complete unfolding of the terminal. The convex and concave portions 122a, 122b of the second hinge member 120 correspondingly fit the concave and convex portions 133a, 133b, respectively, of the coupling hinge member 130. This corresponding fit between the second coupling hinge member 120 and the coupling hinge member 130 acts as a locking mechanism to prevent unintentional folding of the terminal and maintain the maximum opening angle.

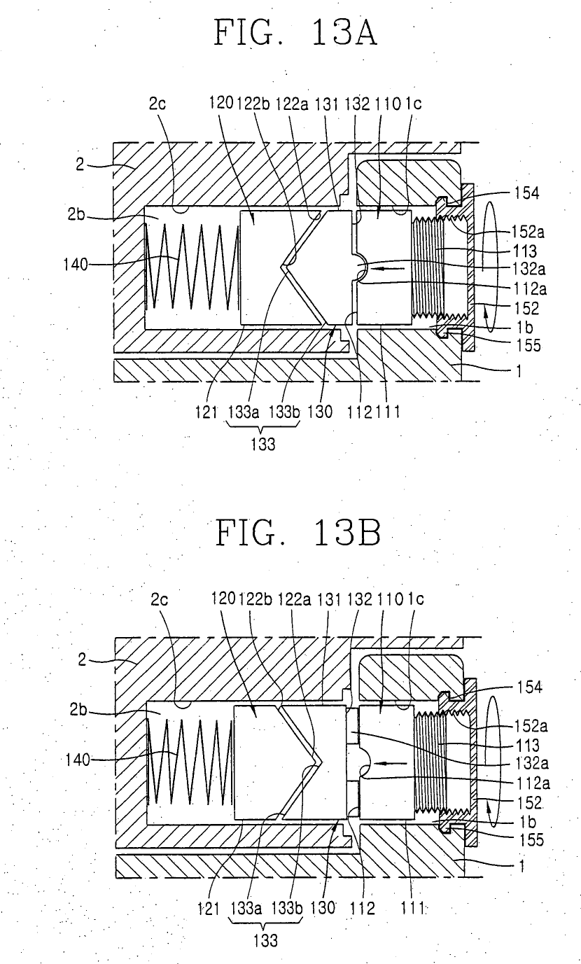

FIGS. 13A and 13B also illustrate operation of a hinge apparatus according to one embodiment of the present invention. In FIG. 13A, a user rotates the rotation control cap 152 in a counter-clockwise direction (as indicated by the circular arrow). Consequently, the female screw threads 152a operationally disengage the male screw threads 113 of the first hinge member 110, resulting in lateral movement of the first hinge member 110 inwards with respect to the terminal's first body 1(as indicated by the directional arrow). In other words, the first hinge member 110 is pushed inwards from the rotational force generated by the user on the cap 152. Furthermore, the coupling hinge member 130 and second hinge member 120 are pushed inwards as well by the movement of the first hinge member, thereby compressing the spring 140.

Prior to rotation of the cap 152 either clockwise (as shown in FIG. 12A) or counter-clockwise (as shown in FIG. 13A), the engagement of the groove 112a to the protrusion 132a acts as a locking mechanism to prevent unintentional unfolding of the terminal. However, as the user unfolds the terminal at the stage shown in FIG. 9A (after counter-clockwise rotation of the cap 152), the coupling hinge member 130 rotates with the second body 2 of the terminal. The rotation-preventing surface 131 of the coupling hinge member 130, which is in contact with the second hinge member contact surface 2c, prevents rotation of the member 130. Furthermore, unfolding the terminal results in the application of shear force to the guiding surfaces 112, 132.

Referring to FIG. 13B, further unfolding of the terminal results in the protrusion 132a rotating and disengaging with the groove 112. Thereinafter, the protrusion is in contact with the guide surface 112. As a result, a frictional force is generated by this contact, which allows the user to select and maintain an opening angle of the terminal. Preferably, complete unfolding of the terminal preferably results in the protrusion 132a completing one revolution so that it engages the groove 112a, once again, and thereby locking the terminal in this position.

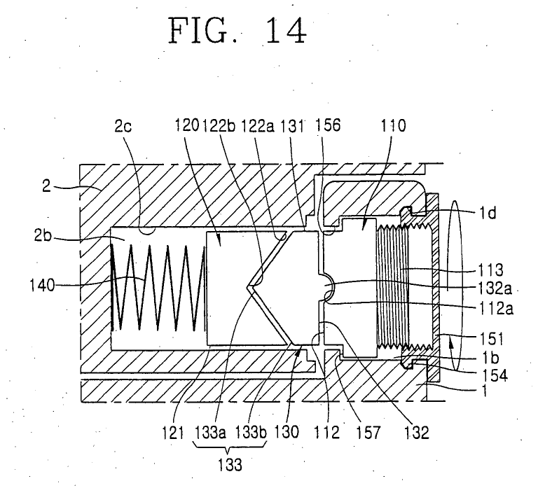

FIG. 14 illustrates a sectional view of an operation of a hinge apparatus according to an alternative embodiment of the present invention. In this embodiment, a stopping protrusion 156 is formed on the inner circumferential surface, preferably towards the inner edge, of the first hinge housing 1b. The protrusion 156 prevents excess lateral movement of the first hinge member 110 towards the second hinge housing 2b, on which a corresponding protrusion 157 is also formed on the first hinge member 110. Therefore, unfolding of the terminal would not result in the first hinge member 110 rotating with the second body 2 of the terminal.

It will be apparent to those skilled in the art that various modifications and variations can be made in the present invention without departing from the spirit or scope of the invention. Therefore, the foregoing description of these embodiments of the present invention has been presented for the purposes of illustration and description. It is not intended to be exhaustive or to limit the invention to the precise form disclosed. Thus, it is intended that the present invention cover the modifications and variations of this invention provided they come within the scope of the appended claims and their equivalents. Preferred embodiments were shown in the context of folding type mobile communication terminals.

What is claimed is:

1. A mobile communication terminal comprising:
a first body;
a second body; and
a hinge apparatus, which rotatively couples the first body to the second body, the hinge apparatus comprising:
a first hinge unit;
a second hinge unit;
a coupling hinge member disposed between the first and second hinge units; and
a rotation control device.

2. The mobile communication terminal of claim 1, wherein the first hinge unit comprises:
a first hinge housing formed approximate to a side edge of the first body; and
a first hinge member inserted into the first hinge housing.

3. The mobile communication terminal of claim 2, wherein the second hinge unit comprises:
a second hinge housing formed approximate to a bottom edge of the second body;
a second hinge member inserted into the second hinge housing; and
a spring disposed adjacent to the second hinge member in the second hinge housing.

4. The mobile communication terminal of claim 3, further comprising a shaft disposed in the second hinge housing, wherein the shaft passes through the spring, second hinge member and coupling hinge member.

5. The mobile communication terminal of claim 2, wherein guiding surfaces are formed on opposing surfaces of the first hinge member and coupling hinge member.

6. The mobile communication terminal of claim 5, wherein a groove, which is formed on the guiding surface of the first hinge member, engages a corresponding protrusion formed on the guiding surface of the coupling hinge member.

7. The mobile communication terminal of claim 5, wherein a groove, which is formed on the guiding surface of the coupling hinge member, engages a corresponding protrusion formed on the guiding surface of the first hinge member.

8. The mobile communication terminal of claim 3, wherein a convex portion and a concave portion are each formed on opposing surfaces of the coupling hinge member and the second hinge member such that the convex and concave portions of the coupling hinge member correspond to the concave and convex portions, respectively, of the second hinge member.

9. The mobile communication terminal of claim 3, wherein rotation-preventing surfaces are formed on a circumferential surface of each of the first, second and coupling hinge members.

10. The mobile communication terminal of claim 9, wherein first and second hinge contact surfaces are formed on an inner surface of each of the first and second hinge housing members, respectively, to engage the rotation-preventing surfaces of the first and second hinge members, respectively, to prevent rotation of the first and second hinge members, respectively.

11. The mobile communication terminal of claim 2, wherein the rotation control device comprises:
a cap receiving portion formed on an inner surface of the first hinge housing;
a rotation control cap;
a cap receiving groove formed on the cap receiving portion;
a cap protrusion formed on an outer circumferential surface of the rotation control cap, wherein the cap receiving groove receives the cap protrusion;
a female screw thread formed on an inner circumferential surface of the rotation control cap; and
a male screw thread formed on a circumferential surface of the first hinge member, wherein the male screw thread engages the female screw thread of the rotation control cap.

12. The mobile communication terminal of claim 11, wherein the rotation control cap comprises an exposed portion to serve as a receiving point for torque applied by a user.

13. The mobile communication terminal of claim 12, wherein the exposed portion comprises gripping means.

14. The mobile communication terminal of claim 13, wherein the gripping means comprises a plurality of knurls.

15. The mobile communication terminal of claim 11, further comprising a protrusion formed on each of the inner surfaces of the first hinge housing and rotation control cap such that the protrusion formed on the inner surface of the first hinge housing prevents lateral movement of the rotation control cap towards the second hinge housing.

16. The mobile communication terminal of claim 1, wherein a plurality of terminal manipulation devices are disposed on an inner surface of the first body.

17. The mobile communication terminal of claim 1, wherein a display screen is disposed on an inner surface of the second body.

18. A folding type mobile communication terminal, wherein a hinge apparatus rotatively couples a first body to a second body, the hinge apparatus comprising:
a first hinge housing formed approximate to a side edge of the first body;
a first hinge member inserted into the first hinge housing;
a second hinge housing formed approximate to a bottom edge of the second body;
a second hinge member inserted into the second hinge housing;
a coupling hinge member disposed between the first and second hinge members;
a spring disposed adjacent to the second hinge member in the second hinge housing;
a shaft disposed in the second hinge housing, wherein the shaft passes through the spring, second hinge member and coupling hinge member; and
a rotation control device.

19. The folding type mobile communication terminal of claim 18, wherein the hinge apparatus further comprises:
guiding surfaces formed on opposing surfaces of the first hinge member and coupling hinge member, wherein a groove is formed on the guiding surface of the first hinge member and engages a corresponding protrusion formed on the guiding surface of the coupling hinge member.

20. The folding type mobile communication terminal of claim 18, wherein a convex portion and a concave portion are each formed on opposing surfaces of the coupling hinge member and the second hinge member such that the convex and concave portions of the coupling hinge member correspond to the concave and convex portions, respectively, of the second hinge member.

21. The folding type mobile communication terminal of claim 18, wherein the hinge apparatus further comprises:
rotation-preventing surfaces formed on a circumferential surface of each of the first, second and coupling hinge members; and
first and second hinge contact surfaces formed on an inner surface of each of the first and second hinge housing members, respectively, wherein the first and second hinge contact surfaces engage the rotation-preventing surfaces of the first and second hinge members, respectively, to prevent rotation of the first and second hinge members, respectively.

22. The folding type mobile communication terminal of claim 18, wherein the rotation control device comprises:
a cap receiving portion formed on an inner surface of the first hinge housing;
a rotation control cap having an exposed portion to serve as a receiving point for torque applied by a user;
a cap receiving groove formed on the cap receiving portion;
a cap protrusion formed on an outer circumferential surface of the rotation control cap, wherein the cap receiving groove receives the cap protrusion;
a female screw thread formed on an inner circumferential surface of the rotation control cap; and
a male screw thread formed on a circumferential surface of the first hinge member, wherein the male screw thread engages the female screw thread of the rotation control cap.

23. A method of unfolding a folding type mobile communication terminal to a maximum opening angle, the method comprising the steps of:
rotating a rotation control device in a predetermined direction so that a first hinge member is forced towards an outer edge of the terminal, wherein a coupling hinge member is displaced into a first hinge housing;
lifting a first body of the terminal, which is rotatively coupled to a second body, so that a convex portion of the coupling hinge member passes over a convex portion of a second hinge member; and
releasing the first body of the terminal so that a spring housed in a second hinge housing expands and forces the convex portion of the coupling hinge member to completely pass over the convex portion of the second hinge member, thereby completely unfolding the terminal.

24. A method of unfolding a folding type mobile communication terminal to a desired opening angle, the method comprising the steps of:
rotation a rotation control device in a predetermined direction so that a first hinge member is forced away from an outer edge of the terminal, wherein a coupling hinge member is displaced into a second hinge housing;
lifting a first body of the terminal, which is rotatively coupled to a second body, so that a protrusion on the coupling hinge member engages a groove on the first hinge member; and
releasing the first body of the terminal at the desired opening angle, wherein an elastic force generated by a spring housed in a second hinge housing presses the coupling hinge member against the first hinge member, thereby creating a frictional force to maintain the desired opening angle.
